(19) United States
(12) Patent Application Publication
(10) Pub. No.: US 2019/0250567 A1
(43) Pub. Date: Aug. 15, 2019

(54) AUTOMATIC REGULAR TIME SERVICE METHOD AND TIME SERVICE SYSTEM FOR POINTER TYPE INTELLIGENT CLOCK

(71) Applicant: Shenzhen Smartmovt Data Services Co., Ltd., Shenzhen, Guangdong (CN)

(72) Inventors: Hui WANG, Shenzhen, Guangdong (CN); Yucheng JI, Shenzhen, Guangdong (CN)

(21) Appl. No.: 15/775,851

(22) PCT Filed: Dec. 29, 2015
(86) PCT No.: PCT/CN2015/099563

§ 371 Date: May 14, 2018

(30) Foreign Application Priority Data
Dec. 16, 2015 (CN) 201510953201.8

(51) Int. Cl. G04R 20/28

(52) U.S. Cl. CPC G04R 20/28

(57) ABSTRACT

An automatic regular time service method for a pointer type intelligent clock includes the following steps: a clock is connected to a mobile intelligent terminal by a wireless communication module to obtain a standard time; when the clock is not connected to the mobile intelligent terminal, an MCU module calls an internal error correction parameter list regularly by means of a command signal to obtain a correction time; and a movement controls pointers to rotate to synchronize the time to the standard time or correction time. A time service system for a pointer type intelligent clock is also disclosed. The method and the system solve the timekeeping error problem of a clock caused by a crystal oscillator error of a quartz movement, and can perform an automatic time service even if the clock is not connected to the network.

### TECHNICAL FIELD

The present disclosure relates to the field of timing devices, and in particular to automatic time service method and system for a pointer type intelligent clock. The present disclosure is limited to the field of intelligent transformation of a quartz movement taking a crystal oscillator as a time reference.

Further, the present disclosure is limited to the field of pointer type intelligent clocks with a quartz movement.

### BACKGROUND

At present, a quartz watch uses a quartz crystal oscillator for timing control, but the quartz crystal oscillator itself has a frequency error, which may cause a timekeeping error of a second or so in a single day and night at normal temperature. However, the conventional quartz watches do not have a time correction function but can only be manually corrected when the errors are accumulated to some extent. The crystal oscillator with a small frequency error is also very expensive, which leads to the fact that the degree of accuracy of the quartz watch depends on the precision of the crystal oscillator.

Moreover, there are now technologies that can perform time service on the watches through GPS or radio waves. Taking the radio wave time correction as an example, a radio-controlled clock, by combining the traditional clock technology with the modern time-frequency technology, microelectronic technology, communication technology, computer technology and other technologies, receives a standard time signal transmitted by means of long radio waves from the National Time Service Center, and decodes the standard time signal by a built-in microprocessor to correct the timekeeping, so that the time displayed by the radio-controlled clock and the standard time maintained by the State keep precision synchronization automatically. The technology is unique in that there is a built-in radio receiving antenna that can automatically receive a “standard time” radio wave transmitted from a clock synchronization base station every day, and this standard time radio wave contains information to receive a current correct time, including year, month, day, hour, minute and second, and after receiving the correction time, the radio-controlled clock can automatically correct the moment and calendar and display a correct time. Since a timing device of the clock synchronization transmitting base station is made from rare Cesium atoms and has only one-second error every 100,000 years, it can keep the standard time almost permanently. The radio wave watch is provided with a small built-in antenna with high-sensitivity which receives the standard radio waves and performs automatic clock synchronization, thereby realizing a precise time. At the international level, Germany, the United Kingdom, the United States and Japan have already transmitted the standard radio waves.

However, the time service technology represented by the radio-controlled clock has the following problems. First, it depends greatly on the radio transmission signal, and cannot perform the time service in case of bad connection. Second, the problem of pointer offset error cannot be solved. Specifically, a mechanical deviation will occur in a pointer type watch during the movement of pointers, resulting in that a time actually indicated by the pointers may not be consistent with the internal time of the watch. Therefore, the radio time service can only ensure that the time of an internal movement of the watch is consistent with the actual time, but fails to solve the problem that whether the time indicated by the pointers is consistent with the time of the internal movement of the watch.

Hence, the conventional pointer type watches with the crystal oscillator have the following problems of: 1. the time error caused by the crystal oscillator error; 2. the dependence of the radio time service on the radio network in order to solve problem 1; and 3. the mechanical error of the pointers of the pointer type watch. Therefore, even if the automatic time service is successful, the time of the internal MCU movement of the watch may not be consistent with the time actually indicated by the pointers.

### SUMMARY

The problem to be solved by the present disclosure is to provide a smart watch that can automatically perform error compensation according to multiple time service. The present disclosure also includes a time service system for a smart watch.

The present disclosure includes the following technical features: an automatic regular time service method for a pointer type intelligent clock is provided, the clock including an MCU module, a quartz crystal oscillator as a time reference, a movement for driving pointers to rotate, and a wireless communication module communicated with a mobile intelligent terminal, wherein the automatic time service method includes the following steps:

Q1: obtaining, by the mobile intelligent terminal, a standard time through a registered operator network;

Q2: proceeding to Q3 if the mobile intelligent terminal is connected to the clock via the wireless communication module; skipping to Q4 if not;

Q3: sending, by the clock, a request to the mobile intelligent terminal regularly, and sending, by the mobile intelligent terminal, a standard time to the clock by means of a command signal based on the request; or, sending actively and regularly, by the mobile intelligent terminal, a standard time to the clock by means of a command signal;

Q4: calling, by the MCU module, an internal error correction parameter list regularly by means of a command signal;

Q5: analyzing, by the MCU module, the command signal in Q3 or Q4 and comparing it with a current internal time of the MCU module; synchronizing a time to a correction time through controlling, by the movement, the pointers to rotate if current internal time data is not synchronized with time data of the command signal; or not carrying out time service if current time data of the clock is synchronized with the time data of the command signal; and

Q6: in case of proceeding to Q3, storing, by the MCU module, comparison data of the standard time obtained in Q3 and the internal time in Q5 to generate an error correction parameter list for long-term accurate timekeeping.

The method adopted by the present disclosure has the following beneficial effects. First, a time error problem caused by a crystal oscillator error is solved. A correct time is obtained by connecting the mobile intelligent terminal to the network of an operator base station, and then the intelligent terminal performs Bluetooth zero correction, time service and other control operations on other intelligent clocks, and can obtain a correct time source even in indoor or closed environments without satellite signal coverage, so that the problem that the time is inaccurate due to the crystal oscillator error is overcome, thus the precision of the crystal oscillator used in the smart watch can be lowered, thereby saving the cost of the smart watch.

Second, the problem that the traditional time service watch must be connected to the radio network is solved. The inventors have found through numerous studies that the errors of the quartz crystal oscillator are homogenous, i.e., the same quartz crystal oscillator tends to have the same positive deviation (or negative deviation) at the same time interval. Therefore, it is possible to calculate the error value of the quartz crystal oscillator by multiple measurements over a long period of time, and then compensate the error value at regular intervals to ensure the accuracy of the time. In the present disclosure, the error of the quartz crystal oscillator is obtained through dynamic learning of big data of many times of regular time services, and the clock can ensure an accurate time by means of automatic compensation even if the clock is not connected to the network.

Preferably, the error correction parameter list is obtained by calculating a mean of all the stored comparison data every time the comparison data of the standard time obtained in Q3 and the internal time in Q5 is stored in a database, and then using the mean as an error correction parameter for long-term accurate timekeeping. Due to the dynamic learning of a large amount of big data, a large amount of comparative data must be obtained and then the mean thereof is calculated to obtain an error value of the crystal oscillator, and the error value is dynamically corrected for several times, thus ensuring the timely update and accuracy of the data.

Preferably, the error correction parameter is corrected in real time every time the regular time service in Q3 is carried out; in case of the time service being not carried out in Q3, the error correction parameter is not modified; and the correction parameter is stored in a memory that is not affected by the external power outage. Since this error correction parameter is significative only in the case of the data being obtained by performing Q3, the data needs to be filtered. If it is not the data obtained from the regular time service, e.g., it is the data obtained from a single time service performed by a user, since there are individual requirements for time service in this case, the data should not be included in the error correction parameters, and the comparison value, without reference significance to the error correction parameters, should be excluded. In addition, the error correction parameter is a result obtained from big data and matched with the crystal oscillator of the smart watch, and the longer the time is, the higher the precision and the higher the value is, so it should be stored in a memory that is not affected by the external power outage.

Preferably, the regular time service refers to a service time every 24×N hours and N is an integer greater than or equal to 1.

Preferably, the wireless communication module is a Bluetooth-low-energy communication module, preferably a Bluetooth-low-energy communication module based on a Bluetooth 4.0 standard. The Bluetooth-low-energy communication module based on the Bluetooth 4.0 standard can greatly reduce energy consumption and prolong the service life of smart watches.

Preferably, further comprising, before the automatic time service, a pointer calibration step to ensure that a time indicated by the pointers on a dial is consistent with the current internal time of the MCU module.

The mechanical error problem of the pointers of the pointer type watch to be solved by the preferred embodiment is a unique problem of the pointer type watch. The pointers of the pointer type clock are supported on a rotating shaft during operation, and the structure resembles a lever, so that a mechanical error due to external vibration is easily generated during the operation, and the MCU of the watch cannot identify such deviation. For example, an internal time of the MCU of a watch is 12 o'clock, but the time actually indicated by the pointers may not be exactly at 12 o'clock (such as 12 o'clock and 5 seconds possibly) due to the mechanical error, and it is impossible for the MCU to judge and identify the deviation. The so-called pointer calibration means that the time recorded by an internal MCU of the watch is consistent with the time indicated by the pointers. However, if no pointer calibration is performed, the time indicated by the pointers is not necessarily the standard time even if the time of the internal MCU movement of the watch is the standard time after a successful automatic time service, so the precision of the watch is greatly reduced, thereby affecting the significance of time service. The pointer calibration step is to inform the MCU module of current positions actually indicated by the pointers on the dial, allowing the MCU module to make judgments and adjustments, so that the internal time of the MCU module of the clock is consistent with the time actually indicated by the pointers, and then the time service is performed, thereby further ensuring the accuracy of the time service.

Preferably, the pointer calibration step comprises sending, by the mobile intelligent terminal, positions of the pointers on the dial to the MCU module which adjusts the pointers according to the positions of the pointers on the dial to ensure that the time indicated by the current positions of the pointers is consistent with the current internal time of the MCU module.

Further, the calibration step comprises obtaining, by the mobile intelligent terminal, the positions of the pointers on the dial by photographing or camera shooting through a capturing module. In this preferred embodiment, the positions of the pointers are input by camera shooting and photographing, facilitating a simpler operation.

Further, the calibration step comprises obtaining, by the mobile intelligent terminal, the positions of the pointers on the dial by means of manual key input or touch screen input. In this preferred embodiment, both the manual input and the touch screen input are performed through an intelligent terminal, this input method greatly improves the efficiency of the pointer calibration, and the touch screen input method greatly improves the user's operating experience and operation convenience.

The present disclosure also includes a time service system using the above automatic regular time service method, including an MCU module, a quartz crystal oscillator as a time reference, a movement for driving pointers to rotate, and a wireless communication module communicated with a mobile intelligent terminal, wherein the mobile intelligent terminal is an intelligent phone connected to the network of an operator base station, the wireless communication module is a Bluetooth or Bluetooth-low-energy module; the intelligent phone, the MCU module and the wireless communication module are connected to each other by a circuit, and the MCU module is connected to the movement for driving the pointers to rotate; and the pointers and the movement are connected by a steering shaft, and the MCU module is configured to analyze commands and operate based on the commands, so as to adjust positions of the pointers by controlling the pointers to rotate through the movement.

The time service system using the automatic time service method provided by the present disclosure also solves the time error problem caused by the crystal oscillator error, and solves the problem that the traditional time service clocks must be connected to the wireless network. Further, this time service system also solves the pointer error problem of the pointer type smart watch. By using the time service method and system of the present disclosure, an omni-directional solution for the precision of the smart watch is provided, which solves the error problem of the crystal oscillator, the dependence of the intelligent time service on the network, and the pointer error of the pointer type watch at the same time.

### BRIEF DESCRIPTION OF THE DRAWINGS

FIG. 1 is a schematic flow chart showing steps of an automatic regular time service method according to the present disclosure;

FIG. 2 is a diagram showing connection of modules of a time service system according to the present disclosure;

FIG. 3 is a schematic diagram showing positions of physical pointers with input by a touch screen according to the present disclosure; and

FIG. 4 is a schematic diagram showing the positions of the physical pointers with input by photographing or camera shooting according to the present disclosure.

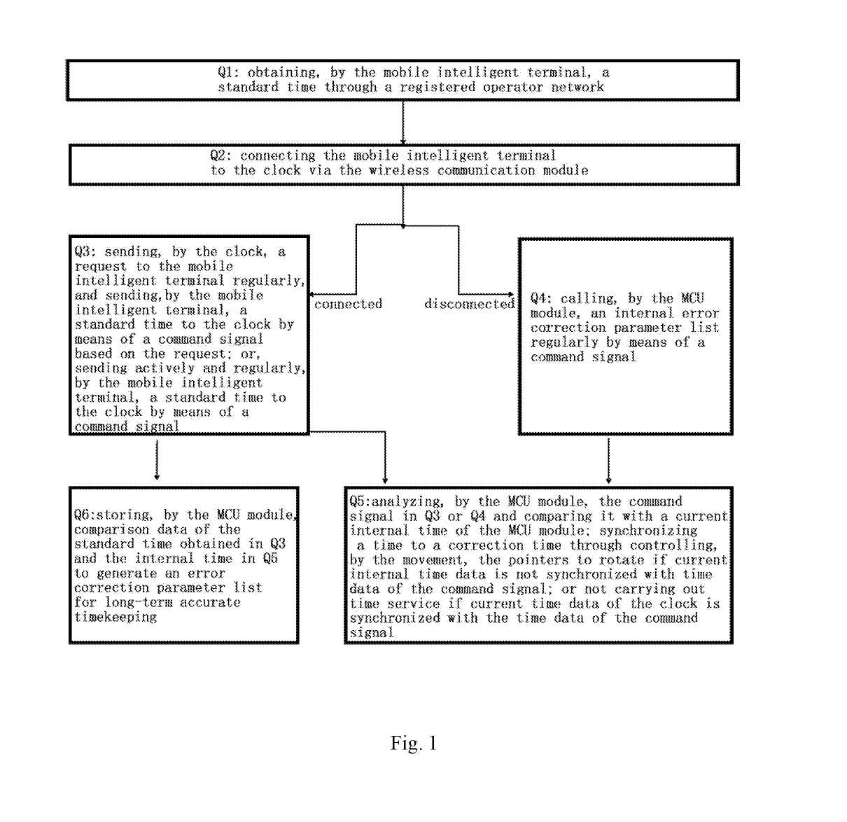

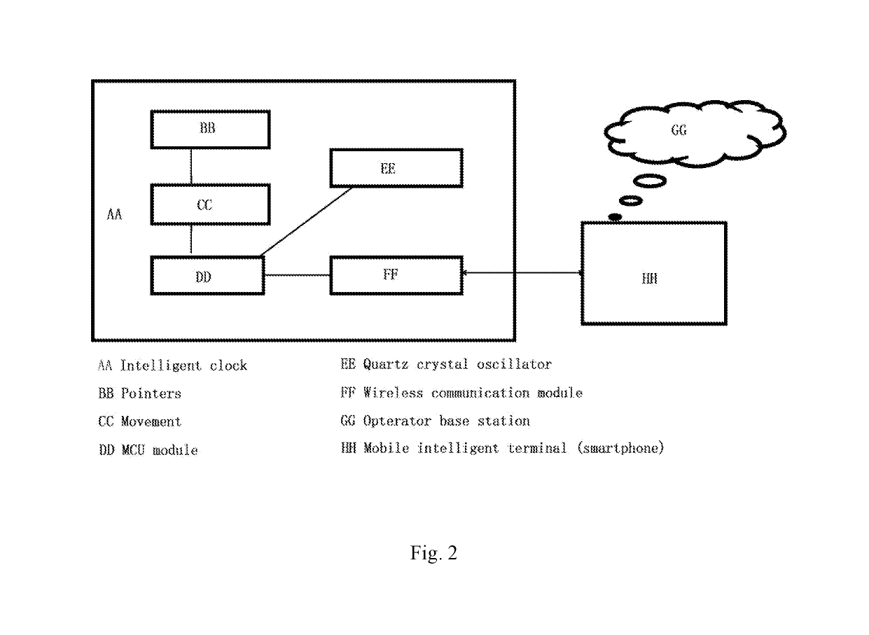

### DETAILED DESCRIPTION OF THE EMBODIMENTS

According to specific embodiments of the present disclosure, a technical solution of automatic time service for a smart watch is provided. The technical problem solved by the technical solution of the intelligent time service is directed to a smart watch that performs timing control by using a quartz crystal oscillator, and further to clock equipment with pointers. The technical solution of this embodiment is as follows:

An automatic regular time service method for a pointer type intelligent clock is provided, wherein the clock includes an MCU module, a quartz crystal oscillator as a time reference, a movement for driving pointers to rotate, and a wireless communication module communicated with a mobile intelligent terminal. The wireless communication module is a Bluetooth-low-energy communication module, preferably a Bluetooth-low-energy communication module based on a Bluetooth 4.0 standard.

The automatic time service method comprises the following steps:

Q1: obtaining, by the mobile intelligent terminal, a standard time through a registered operator network;

Q2: proceeding to Q3 if the mobile intelligent terminal is connected to the clock via the wireless communication module; skipping to Q4 if not;

Q3: sending, by the clock, a request to the mobile intelligent terminal regularly, and sending by the mobile intelligent terminal a standard time to the clock by means of a command signal based on the request; or, sending actively and regularly, by the mobile intelligent terminal, a standard time to the clock by means of a command signal;

Q4: calling by the MCU module an internal error correction parameter list regularly by means of a command signal; wherein the error correction parameter list is obtained by calculating a mean of all the stored comparison data every time the comparison data of the standard time obtained in Q3 and the internal time in Q5 is stored in a database, and then using the mean as an error correction parameter for long-term accurate timekeeping;

Q5: analyzing, by the MCU module, the command signal in Q3 or Q4 and comparing it with a current internal time of the MCU module; synchronizing a time to a correction time through controlling, by the movement, the pointers to rotate if current internal time data is not synchronized with time data of the command signal; or not carrying out time service if current time data of the clock is synchronized with the time data of the command signal; and

Q6: in case of proceeding to Q3, storing by the MCU module comparison data of the standard time obtained in Q3 and the internal time in Q5 to generate an error correction parameter list for long-term accurate timekeeping.

The error correction parameter is corrected in real time every time the regular time service in Q3 is carried out; in case of the time service being not carried out in Q3, the error correction parameter is not modified; and the correction parameter is stored in a memory that is not affected by the external power outage. The regular time service refers to a service time every 24×N hours and N is an integer greater than or equal to 1.

In the above embodiment, the smart watch can perform a time service through the network, or can also learn a crystal oscillator error value of the smart watch according to each time service, and can automatically compensate the crystal oscillator according to the learned error value in case that it is not connected to the network. Therefore, the solution solves the time error problem caused by the crystal oscillator error. A correct time is obtained by connecting the mobile intelligent terminal to the network of an operator base station, and then the intelligent terminal performs the Bluetooth zero correction, time service and other control operations on other smart watches, and can obtain a correct time source even in indoor or closed environments without satellite signal overage, so that the problem that the time is inaccurate due to the crystal oscillator error is overcome, thus the precision of the crystal oscillator used in the smart watch can be lowered, thereby saving the cost of the smart watch.

Second, the problem that the traditional time service watch must be connected to the radio network is solved. The inventors have found through numerous studies that the errors of the quartz crystal oscillator are homogenous, i.e., the same quartz crystal oscillator tends to have the same positive deviation (or negative deviation) at the same time interval. Therefore, it is possible to calculate the error value of the quartz crystal oscillator by multiple measurements over a long period of time, and then compensate the error value at regular intervals to ensure the accuracy of the time. In the present disclosure, the error of the quartz crystal oscillator is obtained through dynamic learning of big data of many times of regular time services, and the clock can ensure an accurate time by means of automatic compensation even if it is not connected to the network.

To solve the problem of pointer offset, further comprising, before the automatic time service, a pointer calibration step to ensure that a time indicated by the pointers on a dial is consistent with the current internal time of the MCU module. The pointer calibration step comprises sending by the mobile intelligent terminal positions of the pointers on the dial to the MCU module, and adjusting by the MCU module the pointers according to the positions of the pointers on the dial to ensure that the time indicated by the current positions of the pointers is consistent with the current internal time of the MCU module.

There are several methods for the mobile intelligent terminal to send the positions of the pointers on the dial to the MCU module: in the calibration step, the mobile intelligent terminal obtains the positions of the pointers on the dial by photographing or camera shooting through a capturing module. Alternatively, in the calibration step, the mobile intelligent terminal obtains the positions of the pointers on the dial by means of manual key input or touch screen input.

The above several methods for obtaining the positions of the pointers on the dial will be described as below:

I. A Method for Obtaining the Positions of the Pointers on the Dial by Means of Touch Screen Input Includes the Following Steps:

A1: establishing by the intelligent terminal a wireless connection with the clock. The wireless connection employs conventional wireless connection technologies such as Bluetooth and infrared technologies, preferably a Bluetooth-low-energy technology, such as a technology based on Bluetooth standard 4.0 and above.

A2: stopping rotation of the physical pointers when the clock is in a state of calibration. As the pointers are to be calibrated, the physical pointers of the clock must be kept still. Here, a calibration mode, in which the physical pointers stop rotating, can be set.

A3: displaying in a touch screen of the mobile intelligent terminal a screen dial and screen pointers; identifying, by the touch screen, touch tracks and enabling an image of the screen pointers to dynamically change based on the changes in the identified touch tracks, and inputting manually the touch tracks to make end points of the screen pointers as the current positions of the physical pointers; and recording, by the mobile intelligent terminal, the time corresponding to the positions of the screen pointers. This step is to inform the mobile intelligent terminal of the positions of the physical pointers through the touch screen, so that the intelligent terminal records the current positions of the physical pointers. In order to increase the interactivity of the calibration, the screen display dial and the screen display pointers are displayed on the touch screen, so that the user can directly move the screen pointers on the screen.

Further, the dynamic changes of the screen pointers with the finger touch is achieved by the specific steps: first, A301: providing a position of a coordinate zero point that can be recorded by the mobile intelligent terminal on the screen dial of the touch screen; A302: identifying by the touch screen coordinates of a touch start point which are recorded by the mobile intelligent terminal; A303: pointing by the screen pointers to the touch start point, identifying by the touch screen coordinates of a touch track change process which are dynamically identified and called to the screen pointers, and the screen pointers varying with the change in the touch track; A304: identifying by the touch screen coordinates of a touch end point which are recorded by the mobile intelligent terminal; and A305: calculating an angular variation of the touch track based on the coordinates of the touch start point, the coordinates of the touch end point and the position of the coordinate zero point, to obtain time data corresponding to the screen pointers.

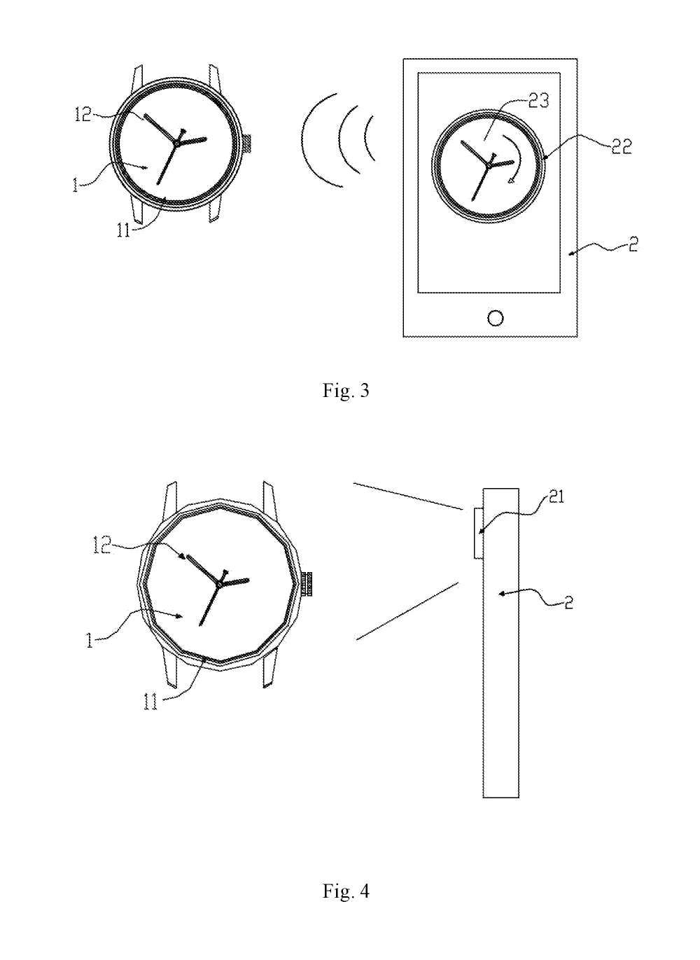

For better description, referring to FIG. 3, which includes an intelligent clock 1, and a physical dial 11 and physical pointers 12 of the intelligent clock. It also includes a mobile intelligent terminal 2, including a screen dial 21 and screen pointers 22. During the adjustment, the user touches the screen dial 21 of the intelligent terminal by hand, the screen pointers 22 vary with a touch movement track, the user moves the screen pointers 22 to the same positions as the physical pointers, and stops touching, and the mobile intelligent terminal can work out current positions of the physical pointers 12 and obtain the corresponding time data.

Finally, A4: transmitting by the mobile intelligent terminal the recorded data of the screen pointers to the clock by means of a command signal, and synchronizing the MCU module of the clock with the physical pointers after analyzing the signal so as to achieve that the time in the MCU module is consistent with that indicated by the physical pointers. At this moment, the mobile intelligent terminal informs the intelligent clock of the positions of the physical pointers, and the time corresponding to these positions is compared by the intelligent lock with the internal time of the MCU module and finally adjusted to synchronization. This step specifically includes: A401, making a judgment by the MCU module after obtaining the positions of the physical pointers; and A402, if the internal time of the MCU module is consistent with the time indicated by the physical pointers, terminate the calibration; if the internal time of the MCU module is not consistent with the time indicated by the physical pointers, calculate by the MCU module a difference value between the two, and send a command to drive the physical pointers to the same positions corresponding to the internal time of the MCU module before continuing to rotate.

II. A Method for Obtaining the Positions of the Pointers on the Dial by Means of Photographing Includes the Following Steps:

First, A1: establishing by the intelligent terminal a wireless connection with the clock; the wireless connection employs conventional wireless connection technologies such as Bluetooth and infrared technologies, preferably a Bluetooth-low-energy technology, such as a technology based on Bluetooth standard 4.0 and above.

Second, A2: stopping rotation of the physical pointers when the clock is in a state of calibration. As the pointers are to be calibrated, the physical pointers of the clock must be kept still. Here, a calibration mode, in which the physical pointers stop rotating, can be set.

A3: capturing, by the mobile intelligent terminal, an image of the dial and the pointers to obtain time data corresponding to the physical pointers after the captured image is identified. Further, A3 specifically includes the following steps:

A301: capturing, by the mobile intelligent terminal, an image of the dial and the pointers;

A302: performing pixel analysis on the image to identify and read scale coordinate data of the pointers and the dial through the pixel identification;

A303: obtaining positions of the pointers relative to the dial scale based on the scale coordinate data of the pointers and the dial; and

A304: obtaining the time data corresponding to the physical pointers according to the data of the relative positions.

In another preferred embodiment, the pointers and the dial scale are coated, inlaid or embedded with a marking material; the capturing module can identify the marking material; and A3 specifically includes the following steps:

A301: capturing, by the mobile intelligent terminal, an image of the dial and the pointers;

A302: obtaining scale coordinate data of the pointers and the dial from information of the marking material of the image;

A303: obtaining positions of the pointers relative to the dial scale based on the scale coordinate data of the pointers and the dial; and

A304: obtaining the time data corresponding to the physical pointers according to the data of the relative positions.

In this embodiment, the marking material is a fluorescent material, a radioactive isotope material or a reflective material.

The advantage of using the marking material is that it can simplify the image analysis, especially suitable for the situation when there are multiple sets of pointers on the dial. A smart watch with multiple sets of pointers also has a date indicating function in addition to a time indicating function, so the sizes of the pointers on the dial are relatively small, and there is a high probability of incorrect identification by using only the pixel analysis. Moreover, the status of each set of pointers and the positions thereof on the dial can be obtained timely and accurately by using the marking materials for identification, thereby greatly improving the accuracy of identification.

Finally, A4: transmitting, by the mobile intelligent terminal, the time data to the clock by means of a command signal, and synchronizing the MCU module of the clock with the physical pointers after analyzing the signal so as to achieve that the time in the MCU module is consistent with that indicated by the physical pointers.

Further, the step of synchronizing the MCU module of the clock with the physical pointers in A4 includes the following steps:

A401: making a judgment by the MCU module after obtaining the positions of the physical pointers; and

A402: if the internal time of the MCU module and the physical pointer time are the same, terminate the calibration; if the internal time of the MCU module is not consistent with the time indicated by the physical pointers, calculate, by the MCU module, a difference value between the two, and sends a command to drive the physical pointers to the same positions corresponding to the internal time of the MCU module before continuing to rotate.

For better description, referring to FIG. 4, which includes an intelligent clock 1, and a physical dial 11 and physical pointers 12 of the intelligent clock. It also includes a mobile intelligent terminal 2, including a capturing module 21. During the adjustment, the capturing module 21 captures an image of the dial of the intelligent clock, and the mobile intelligent terminal can calculate current positions of the physical pointers 12 and obtain the corresponding time data.

III. A Method for Obtaining the Positions of the Pointers on the Dial by Camera Shooting Includes the Following Steps:

First A1: establishing, by the intelligent terminal, a wireless connection with the clock; the wireless connection can be a Bluetooth-low-energy wireless connection technology, such as a Bluetooth connection technology based on Bluetooth standard 4.0 and above.

A2: performing, by the mobile intelligent terminal, the camera shooting on the dial and the pointers; identifying, by the mobile intelligent terminal, real-time image data, and obtaining moving coordinates of the physical pointers to calculate the time data indicated by the physical pointers. This step specifically includes the following steps:

A201: performing, by the mobile intelligent terminal, the camera shooting on the dial and the pointers to obtain an image of the pointers moving over a period of time; A202: performing the pixel analysis on the image to identify and read the scale coordinate data and a change speed of the pointers and the dial through pixel identification; and A203: calculating the coordinate positions and movement trend of the current physical pointers from the coordinate data and the change speed; and A204: forming a command signal of the time data from the coordinate positions and movement trend of the physical pointers.

In order to improve the accuracy of identification, the pointers and the dial scale are coated, inlaid or embedded with a marking material; and the camera shooting module can identify the marking material. The marking material is a fluorescent material, a radioactive isotope material or a reflective material.

Finally, A3: transmitting, by the mobile intelligent terminal, the time data to the clock by means of the command signal, and synchronizing the MCU module of the clock with the physical pointers after analyzing the signal so as to achieve that the MCU module is consistent with the movement positions of the physical pointers. This step specifically includes A401: making a judgment by the MCU module after obtaining the time data of the physical pointers; and A402: if the internal time of the MCU module is consistent with the position of the time data, terminate the calibration; if the internal time of the MCU module is not consistent with the time indicated by the physical pointers, calculate, by the MCU module, a difference value between the two, and sends a command to drive the physical pointers to the same positions corresponding to the internal time of the MCU module before continuing to rotate.

For better description, referring to FIG. 4, which includes an intelligent clock 1, and a physical dial 11 and physical pointers 12 of the intelligent clock. It also includes a mobile intelligent terminal 2, including a camera shooting module 21. During the adjustment, the camera shooting module 21 performs the camera shooting on the dial of the intelligent clock, and the mobile intelligent terminal can calculate current positions of the physical pointers 12 and obtain the corresponding time data.

Of course, the present disclosure also discloses a system using the above method. The system includes an MCU module, a quartz crystal oscillator as a time reference, a movement for driving pointers to rotate, and a wireless communication module communicated with a mobile intelligent terminal, wherein the mobile intelligent terminal is an intelligent phone connected to the network of an operator base station, the wireless communication module is a Bluetooth or Bluetooth-low-energy module, the intelligent phone, the MCU module and the wireless communication module are connected to each other by a circuit, and the MCU module is connected to the movement which is configured to drive the pointers to rotate; the pointers and the movement are connected by a steering shaft, and the MCU module is configured to analyze commands and operate based on the commands to adjust positions of the pointers by controlling the pointers to rotate through the movement.

Based on the disclosure and teachings of the above description, a person skilled in the art can also make variations or modifications to the above embodiments. Therefore, the present invention is not limited to the specific embodiments disclosed and described above, and some modifications and variations of the present invention should also fall into the protection scope of the claims of the present invention. Also, the above description has used some certain specific terms, but these terms are only intended for convenient description and should not constitute any limitation to the present invention.

1. An automatic regular time service method for a pointer type intelligent clock, the clock comprising an MCU module, a quartz crystal oscillator as a time reference, a movement for driving pointers to rotate, and a wireless communication module communicated with a mobile intelligent terminal, the automatic time service method comprising the steps:
Q1: obtaining, by the mobile intelligent terminal, a standard time through a registered operator network;
Q2: proceeding to Q3 if the mobile intelligent terminal is connected to the clock via the wireless communication module; skipping to Q4 if not;
Q3: sending, by the clock, a request to the mobile intelligent terminal regularly, and sending, by the mobile intelligent terminal, a standard time to the clock by means of a command signal based on the request; or, sending actively and regularly, by the mobile intelligent terminal, a standard time to the clock by means of a command signal;
Q4: calling, by the MCU module, an internal error correction parameter list regularly by means of a command signal;
Q5: analyzing, by the MCU module, the command signal in Q3 or Q4 and comparing it with a current internal time of the MCU module; synchronizing a time to a correction time through controlling, by the movement, the pointers to rotate if current internal time data is not synchronized with time data of the command signal; or not carrying out time service if current time data of the clock is synchronized with the time data of the command signal; and
Q6: in case of proceeding to Q3, storing, by the MCU module, comparison data of the standard time obtained in Q3 and the internal time in Q5 to generate an error correction parameter list for long-term accurate timekeeping.

2. The automatic regular time service method for a pointer type intelligent clock according to claim 1, wherein the error correction parameter list is obtained by calculating a mean of all the stored comparison data every time the comparison data of the standard time obtained in Q3 and the internal time in Q5 is stored in a database, and then using the mean as an error correction parameter for long-term accurate timekeeping.

3. The automatic regular time service method for a pointer type intelligent clock according to claim 2, wherein the error correction parameter is corrected in real time every time the regular time service in Q3 is carried out; in case of the time service being not carried out in Q3, the error correction parameter is not modified; and the correction parameter is stored in a memory that is not affected by the external power outage.

4. The automatic regular time service method for a pointer type intelligent clock according to claim 1, wherein the regular time service refers to a service time every 24×N hours and N is an integer greater than or equal to 1.

5. The automatic regular time service method for a pointer type intelligent clock according to claim 1, wherein the wireless communication module is a Bluetooth-low-energy communication module, preferably a Bluetooth-low-energy communication module based on a Bluetooth 4.0 standard.

6. The automatic regular time service method according to claim 1, further comprising, before the automatic time service, a pointer calibration step to ensure that a time indicated by the pointers on a dial is consistent with the current internal time of the MCU module.

7. The automatic regular time service method according to claim 6, wherein the pointer calibration step comprises sending by the mobile intelligent terminal positions of the pointers on the dial to the MCU module, and adjusting by the MCU module the pointers according to the positions of the pointers on the dial to ensure that the time indicated by the current positions of the pointers is consistent with the current internal time of the MCU module.

8. The automatic regular time service method according to claim 7, wherein the calibration step comprises obtaining by the mobile intelligent terminal the positions of the pointers on the dial by photographing or camera shooting through a capturing module.

9. The automatic regular time service method according to claim 7, wherein the calibration step comprises obtaining by the mobile intelligent terminal the positions of the pointers on the dial by means of manual key input or touch screen input.

10. A time service system using the automatic regular time service method according to claim 1, comprising:
an MCU module;
a quartz crystal oscillator as a time reference;
a mobile intelligent terminal, which is an intelligent phone connected to an operator base station network;
a wireless communication module communicated with the mobile intelligent terminal, the wireless communication module being a Bluetooth or Bluetooth-low-energy module; the intelligent phone, the MCU module and the wireless communication module being connected to each other by a circuit;
a movement for driving pointers to rotate, which is connected to the MCU module, and the pointers being connected to the movement by a steering shaft;
wherein the MCU module is configured to analyze commands and operate based on the commands to adjust positions of the pointers by controlling the pointers to rotate through the movement.
